(19) United States
(12) Patent Application Publication
(10) Pub. No.: US 2024/0340421 A1
(43) Pub. Date: Oct. 10, 2024

(54) ENCODING METHOD AND APPARATUS, DECODING METHOD AND APPARATUS, AND CODE STREAM, DEVICE AND READABLE STORAGE MEDIUM

(71) Applicants: ZHEJIANG UNIVERSITY, Hangzhou (CN); GUANGDONG OPPO MOBILE TELECOMMUNICATIONS CORP., LTD., Dongguan (CN)

(72) Inventors: Lu YU, Dongguan (CN); Chuchu WANG, Dongguan (CN); Sicheng LI, Dongguan (CN); Yuxiao BAI, Dongguan (CN); Zhenyu DAI, Dongguan (CN)

(21) Appl. No.: 18/750,387

(22) Filed: Jun. 21, 2024

Related U.S. Application Data
(63) Continuation of application No. PCT/CN2021/140985, filed on Dec. 23, 2021.

(51) Int. Cl. H04N 19/119; H04N 19/176; H04N 19/597

(52) U.S. Cl. CPC H04N 19/119; H04N 19/176; H04N 19/597

(57) ABSTRACT

An encoding method, a decoding method and apparatus are provided. The decoding method includes: according to a code stream, obtaining spliced map set information and video data to be decoded; performing metadata decoding on the spliced map set information, so as to obtain respective auxiliary information in at least two heterogeneous formats; and performing video decoding on the video data, so as to obtain a spliced image, wherein the spliced image is composed of image sub-blocks corresponding to the at least two heterogeneous formats.

### CROSS-REFERENCE TO RELATED APPLICATION(S)

This application is a continuation of International Application No. PCT/CN2021/140985 filed on Dec. 23, 2021 and entitled “ENCODING METHOD AND APPARATUS, DECODING METHOD AND APPARATUS, AND CODE STREAM, DEVICE AND READABLE STORAGE MEDIUM”, the disclosure of which is hereby incorporated by reference in its entirety.

### BACKGROUND

With the continuous development of video encoding technology, the point cloud data, as an important and popular Three-dimensional (3D) object representation method, is widely used in various fields, such as virtual and mixed reality, automatic driving, 3D printing. Compared with the traditional Two-dimensional (2D) picture data, the point cloud data contains more vivid details, which makes the amount of point cloud data very large.

In related technologies, the existing video codec standards do not support encoding the point cloud data and the 2D picture data into a same atlas. When one atlas contains both the 2D picture data and the point cloud data, the point cloud data is usually projected into picture data and then encoding and decoding are performed, so that the detailed information of the point cloud cannot be retained, which results in the quality of viewing viewpoint picture being reduced. If the supporting is required at a system level, the demand for the number of video decoders will be increased, thereby increasing a cost of the implementation.

### SUMMARY

Embodiments of the present disclosure provide an encoding method, a decoding method, a bitstream, an apparatus, a device, and a readable storage medium, which can not only reduce the demand for the number of the video decoders, but also make full use of a processing pixel rate of the video decoder. Moreover, composition quality of the video picture can be improved.

The technical schemes of the embodiments of the present disclosure may be implemented as follows.

In a first aspect, the embodiment of the present disclosure provides a decoding method, including: obtaining, according to a bitstream, spliced atlas information and video data to be decoded; performing metadata decoding on the spliced atlas information to obtain auxiliary information of each of at least two heterogeneous formats; and performing video decoding on the video data to be decoded to obtain a spliced picture, where the spliced picture is composed of patches corresponding to the at least two heterogeneous formats.

In a second aspect, the embodiment of the present disclosure provides an encoding method, including: acquiring patches corresponding to visual data of at least two heterogeneous formats; performing splicing on the patches corresponding to the visual data of the at least two heterogeneous formats, to obtain spliced atlas information and a spliced picture; and encoding the spliced atlas information and the spliced picture, and signalling the obtained encoded bits in a bitstream.

In a seventh aspect, the embodiment of the present disclosure provides a decoding device including a second memory and a second processor. The second memory is configured to store computer programs executable on the second processor. The second processor is configured to perform the method of the first aspect when the computer programs are running.

### BRIEF DESCRIPTION OF THE DRAWINGS

FIG. 1A is a schematic diagram of a data format-based composition framework.

FIG. 1B is a schematic diagram of another data format-based composition framework.

FIG. 2 shows schematic diagrams of a data format-based encoding method and a data format-based decoding method.

FIG. 3A is a schematic diagram of a detailed framework of a video encoder according to an embodiment of the present disclosure.

FIG. 3B is a schematic diagram of a detailed framework of a video decoder according to an embodiment of the present disclosure.

FIG. 4 is a flowchart of a decoding method according to an embodiment of the present disclosure.

FIG. 5 is a flowchart of another decoding method according to an embodiment of the present disclosure.

FIG. 6 is a flowchart of another decoding method according to an embodiment of the present disclosure.

FIG. 7 is a flowchart of an encoding method according to an embodiment of the present disclosure.

FIG. 8 is a flowchart of another encoding method according to an embodiment of the present disclosure.

FIG. 9 is a schematic diagram of a composition structure of an encoding apparatus according to an embodiment of the present disclosure.

FIG. 10 is a schematic diagram of a specific hardware structure of an encoding device according to an embodiment of the present disclosure.

FIG. 11 is a schematic diagram of a composition structure of a decoding apparatus according to an embodiment of the present disclosure.

FIG. 12 is a schematic diagram of a specific hardware structure of a decoding device according to an embodiment of the present disclosure.

FIG. 13 is a schematic diagram of a composition structure of a codec system according to an embodiment of the present disclosure.

### DETAILED DESCRIPTION

In order to enable a more detailed understanding of the features and technical contents of the embodiments of the present disclosure, implementations of the embodiments of the present disclosure will be described in detail below in conjunction with the accompanying drawings, which are provided for illustration only and are not intended to limit the embodiments of the present disclosure.

Unless otherwise defined, all technical and scientific terms used herein have the same meaning as commonly understood by those skilled in the technical field of the present disclosure. The terms used herein is only for the purpose of describing the present disclosure, and is not intended to limit the present disclosure.

In the following description, “some embodiments” are referred to, which describe a subset of all possible embodiments, but it is understood that “some embodiments” may be the same subset or different subsets of all possible embodiments, and may be composited with each other without conflict. It is to be noted that the term “first\second\third” involved in embodiments of the present disclosure is used for distinguishing similar objects and not representing a specific sequence or sequential order. It is to be understood that such used data may be interchangeable under an appropriate circumstance, so that the embodiments of the present disclosure described herein are, for example, capable of being implemented in a sequence other than those illustrated or described herein.

Before further describing the embodiments of the present disclosure in detail, the nouns and terms involved in the embodiments of the present disclosure are described firstly, and the nouns and terms involved in the embodiments of the present disclosure are applicable to the following explanations:
Moving Picture Experts Group (MPEG)
Visual Volumetric Video-based Coding (V3C)
MPEG Immersive Video (MIV)
Point Cloud Compression (PCC)
Video based Point Cloud Compression (V-PCC)
Three Dimensions (3D)
Virtual Reality (VR)
Augmented Reality (AR)
Mix Reality (MR)
Atlas
Picture Patch (Patch)

It is to be understood that, in general, the homogeneous data formats are defined as data formats having the same expression of their origins, and the heterogeneous data formats are defined as data formats with different origins. In the embodiments of the present disclosure, the origin of the homogeneous data format may be abbreviated as the homogeneous origin, and the origins of the heterogeneous data format may be abbreviated as the heterogeneous origin.

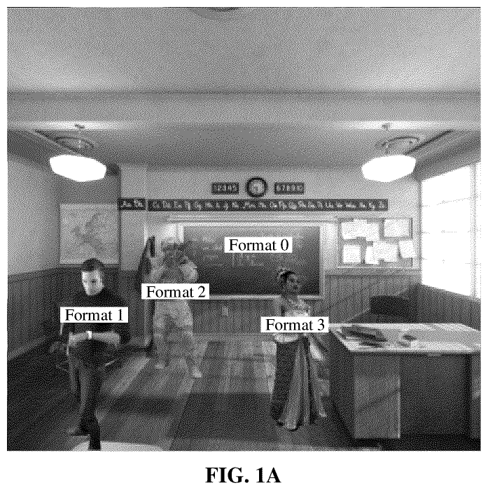

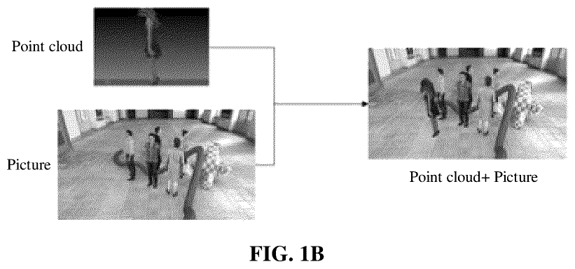

With reference to FIG. 1A, a schematic diagram of a data format-based composition framework is shown. As shown in FIG. 1A, different data format bitstreams may be allowed to be decoded and composited in the same video scene. Both a Format 0 and a Format 1 are picture formats, i.e., the Format 0 and the Format 1 are homogeneous data format; a Format 2 is a point cloud format; and a Format 3 is a mesh format, i.e., the Format 2 and the Format 3 are heterogeneous data formats. That is to say, in FIG. 1A, two heterogeneous data formats (i.e., the Format 2 and the Format 3) are composited with the homogeneous data format (i.e., the Format 0 and the Format 1) in the scene. In this way, a real-time immersive video interaction service can be provided for multiple data formats (e.g., the mesh, the point cloud, the picture, etc.) with different origins.

In a specific example, for the two data formats, i.e., the point cloud and the picture, FIG. 1B shows a schematic diagram of another data format-based composition framework. As shown in FIG. 1B, the point cloud and the picture, as the heterogeneous data formats, may be composited herein, and then encoding and decoding may be independently performed by using a data format-based method. In addition, it is to be noted that the point cloud format is a non-uniform sampling processing, and the picture format is a uniform sampling processing.

In the embodiment of the present disclosure, the data format-based method may allow independent processing at the bitstream level of the data format. That is to say, similar to the tiles or slices in video encoding, different data formats in this scene may be encoded in independent manners, so that both the encoding and the decoding may be performed independently based on the data formats.

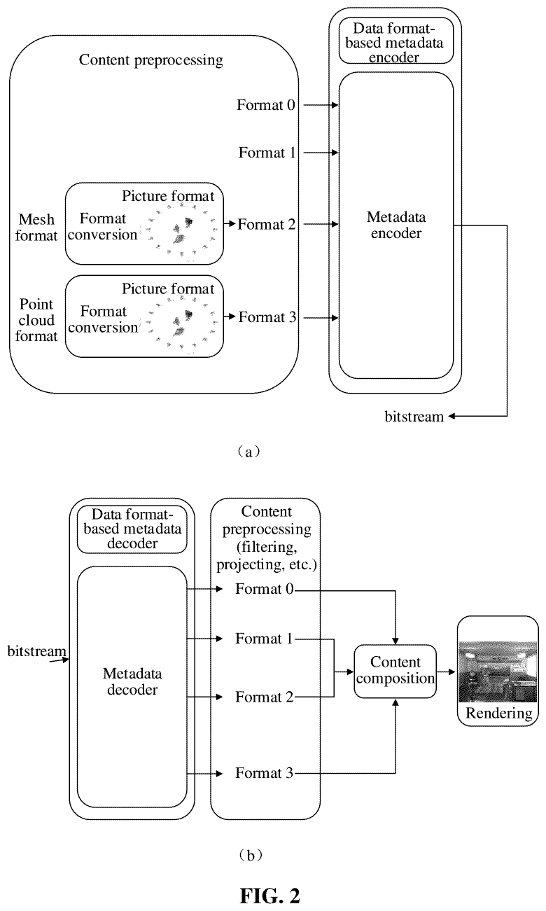

With reference to FIG. 2, schematic diagrams of a data format-based encoding method and a data format-based decoding method are shown. As shown in FIG. 2, (a) shows a flowchart of an encoding method and (b) shows a flowchart of a decoding method.

In (a), for the process of the content preprocessing, each of the Format 0 to Format 3 may be encoded separately. It is assumed that these formats share a common 3D scene. For some data formats from different origins (for example, Format 2 and Format 3), they must be converted into the picture format before encoding. Specifically, the mesh format is required to be converted into the picture format, and the point cloud format is also required to be converted into the picture format. Then the encoding is performed by using a data format-based metadata encoder, to generate a bitstream (or known as “bit stream”).

In (b), the data format-based metadata decoder decodes the received bitstream. In this case, it is necessary to composite the bitstreams obtained by performing the encoding separately based on the data formats into the scene together during the content composition process. In order to improve the rendering efficiency, some data formats may be filtered during the rendering. If the foreign data formats are able to share the same scene, then the foreign data formats (or bitstreams) may be added into the composition process. It is assumed that these data formats share the common 3D scene, some data formats from different origins (e.g., the Format 2 and the Format 3) must also be converted into data formats with the same origin before encoding, and then the subsequent processing is performed.

In this way, each data format may be described independently in the content description by enabling independent data format-based encoding/data format-based decoding. Therefore, the related technology proposes that heterogeneous data formats (such as the mesh data format, the point cloud data format, etc.) may be converted into the picture format (also referred to as “multi-view plane picture format”, “picture plane format”, etc.), which may be used as a new data format and is rendered by using the metadata codec method. The related technology even proposes that virtual-reality mixing may be supported at the system level, for example, the bitstream with the point cloud format may be multiplexed with the bitstream with the picture format at the system level.

However, in the related technology, encoding the heterogeneous data formats into the same atlas is not supported, i.e., one atlas contains both the patch of the picture and the patch of point cloud. If the point cloud is projected into the picture and then encoding and decoding are performed, and the viewpoint picture required to be viewed is rendered based on the reconstructed picture after the decoding, the point cloud actually contains sufficient information for continuous multi-viewpoint viewing. Since the projection before the encoding has only the limited number of viewpoint pictures, part of occlusion information of the point cloud in these viewpoints will be lost during the projection process, which results in the reduction of the quality of a viewing viewpoint picture. If the virtual-reality mixing is supported at the system layer, each data format forms an independent bitstream, multiple bitstreams of different data formats are multiplexed into a composite system layer bitstream by the system layer, and at least one video codec is invoked for the independent bitstream corresponding to each data format, in this case, the demand for the number of video decoders will increase, thereby increasing the cost of the implementation.

The embodiment of the present disclosure provides a decoding method. According to the decoding method, the spliced atlas information and the video data to be decoded are obtained according to a bitstream; the metadata decoding is performed on the spliced atlas information to obtain auxiliary information of each of at least two heterogeneous formats; and the video decoding is performed on the video data to be decoded to obtain a spliced picture, where the spliced picture is composed of the patches corresponding to the at least two heterogeneous formats.

The embodiment of the present disclosure also provides an encoding method. According to the encoding method, the patches corresponding to visual data of at least two heterogenous formats are acquired; splicing is performed on the patches corresponding to the visual data of the at least two heterogeneous formats, to obtain the spliced atlas information and a spliced picture; and the spliced atlas information and the spliced picture are encoded, and the obtained encoded bits are signalled in the bitstream.

In this way, the visual data corresponding to the at least two heterogeneous formats are supported in the same atlas, and then the auxiliary information of each of the at least two heterogeneous formats may be decoded by using different metadata decoders, and the spliced picture composed of the at least two heterogeneous formats may be decoded by using one video decoder, thereby not only implementing the expansion of the codec standards, but also reducing the demand for the number of the video decoders, making full use of the processing pixel rate of the video decoder, and reducing the requirement for the hardware. In addition, since the rendering characteristics from different heterogeneous formats can be retained, the composition quality of the picture is also improved.

The embodiments of the present disclosure will be described in detail below in conjunction with the accompanying drawings.

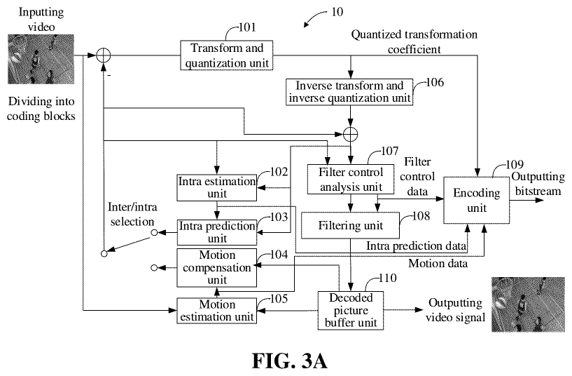

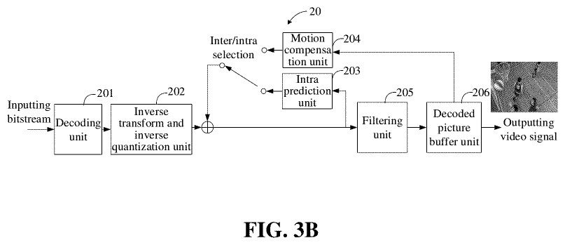

With reference to FIG. 3A, a schematic diagram of a detailed framework of a video encoder according to an embodiment of the present disclosure is shown. As shown in FIG. 3A, the video encoder 10 includes a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, an encoding unit 109, and a decoded picture buffer unit 110. The filtering unit 108 may implement de-blocking filtering and Sample Adaptive Offset (SAO) filtering, and the encoding unit 109 may implement header information encoding and Context-based Adaptive Binary Arithmetic Coding (CABAC). A video coding block can be obtained by the division of the Coding Tree Unit (CTU) for an input original video signal; and then the residual pixel information obtained after intra or inter prediction is transformed by the transform and quantization unit 101, which includes transforming the residual information from a pixel domain to a transform domain, and the obtained transform coefficient is quantized to further reduce the bit rate. The intra estimation unit 102 and the intra prediction unit 103 are configured to perform intra prediction on the video coding block. Specifically, the intra estimation unit 102 and the intra prediction unit 103 are configured to determine an intra prediction mode for encoding the video coding block. The motion compensation unit 104 and the motion estimation unit 105 are configured to perform inter prediction encoding of the received video coding block with respect to one or more blocks of one or more reference pictures to provide temporal prediction information. The motion estimation performed by the motion estimation unit 105 is a process of generating a motion vector, that the motion vector can be used to estimate the motion of the video coding block, and then motion compensation is performed by the motion compensation unit 104 based on the motion vector determined by the motion estimation unit 105. After the intra prediction mode is determined, the intra prediction unit 103 is further configured to provide the selected intra prediction data to the encoding unit 109, and the motion estimation unit 105 also transmits the motion vector data determined by calculating to the encoding unit 109. In addition, the inverse transform and inverse quantization unit 106 is configured to reconstruct the video coding block so as to reconstruct a residual block in the pixel domain; the blocking effect artifact is removed from the reconstructed residual block by the filter control analysis unit 107 and the filtering unit 108, and then the reconstructed residual block is added into a prediction block in the picture of the decoded picture buffer unit 110 to generate the video coding blocks that have been reconstructed. The encoding unit 109 is configured to encode various encoding parameters and quantized transform coefficients, in the CABAC-based coding algorithm, the context content may be based on neighbouring coding block, the encoding unit may be configured to encode information indicating the determined intra prediction mode and output a bitstream of the video signal. The decoded picture buffer unit 110 is configured to store the video coding block that has been reconstructed for prediction reference. As the video picture coding proceeds, new reconstructed video coding blocks are continuously generated, and these reconstructed video coding blocks are stored in the decoded picture buffer unit 110.

With reference to FIG. 3B, a schematic diagram of a detailed framework of a video decoder according to an embodiment of the present disclosure is shown. As shown in FIG. 3B, the video decoder 20 includes a decoding unit 201, an inverse transform and inverse quantization unit 202, an intra prediction unit 203, a motion compensation unit 204, a filtering unit 205, a decoded picture buffer unit 206, and the like. The decoding unit 201 may implement the decoding of the header information and the decoding of the CABAC, and the filtering unit 205 may implement the de-blocking filtering and the SAO filtering. After the input video signal is processed by the video encoding shown in the FIG. 3A, a bitstream of the video signal is output; then the bitstream is input to the video decoder 20 and first passed through the decoding unit 201 for obtaining the decoded transform coefficients. The transform coefficients are processed by the inverse transform and inverse quantization unit 202 to generate residual block in the pixel domain. The intra prediction unit 203 is configured to generate prediction data of a current video coding block based on the determined intra prediction mode and data from a previously decoded block of a current frame or picture. The motion compensation unit 204 is configured to determine the prediction information for the video coding block by parsing the motion vector and other associated syntax elements, and uses the prediction information to generate a prediction block of the video coding block that is being decoded. A residual block from the inverse transform and inverse quantization unit 202 and the corresponding prediction block generated from the intra prediction unit 203 or the motion compensation unit 204 are summed to form a decoded video block. The decoded video signal is processed by the filtering unit 205 to remove the blocking effect artifact, such that the video quality can be improved. Then the decoded video block is stored in the decoded picture buffer unit 206, and the decoded picture buffer unit 206 stores a reference picture for subsequent intra prediction or motion compensation, and is also used for the output of the video signal, that is, the recovered original video signal is obtained.

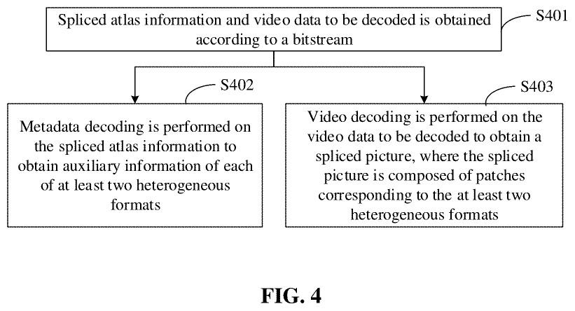

In an embodiment of the present disclosure, with reference to FIG. 4, a flowchart of a decoding method according to an embodiment of the present disclosure is shown. As shown in FIG. 4, the method may include operations S401 to S403.

In operation S401, the spliced atlas information and the video data to be decoded is obtained according to a bitstream.

In operation S402, the metadata decoding is performed on the spliced atlas information to obtain auxiliary information of each of at least two heterogeneous formats.

In operation S403, the video decoding is performed on the video data to be decoded to obtain a spliced picture, where the spliced picture is composed of patches corresponding to the at least two heterogeneous formats.

It is to be noted that in the embodiment of the present disclosure, the patches corresponding to different heterogeneous formats, such as the point cloud and the picture, may coexist in one spliced picture. In this way, only one video decoder is required to decode the patches corresponding to the at least two heterogeneous formats, thereby reducing the demand for the number of the video decoders.

It is also to be noted that in the embodiment of the present disclosure, the auxiliary information of different heterogeneous formats, such as the point cloud and the picture, may coexist in the same atlas. However, in the spliced atlas information, the auxiliary information of each heterogeneous format may be decoded by invoking a respective metadata decoder, so that the rendering characteristics from different heterogeneous formats may be retained.

It is also to be noted that in the embodiment of the present disclosure, one video decoder is used for the sequences belonging to the same spliced picture, while different spliced pictures at the same moment belong to different sequences. In addition, the heterogeneous format described in the embodiment of the present disclosure may indicate that the origins of the data are different, or that the same origin is processed into different data formats, which is not limited herein.

Herein, the spliced atlas information may be formed by splicing the respective pieces of auxiliary information of the visual data of at least two heterogeneous formats. Therefore, in some embodiments, for operation S402, the operation that the metadata decoding is performed on the spliced atlas information to obtain the auxiliary information of each of at least two heterogeneous formats may include following operation.

The metadata decoding is performed, by invoking at least two metadata decoders, on the spliced atlas information to obtain the auxiliary information of each of at least two heterogeneous formats.

That is to say, the spliced atlas information may include the auxiliary information of each of the at least two heterogeneous formats, and for the auxiliary information of each heterogeneous format, a respective metadata decoder may be used for performing the decoding. In other words, in the embodiment of the present disclosure, in case there are a number of types of heterogeneous formats of which the auxiliary information is included in the spliced atlas information, a same number of kinds of metadata decoders are required, that is, there is a correspondence between the number of the metadata decoders and the number of heterogeneous formats.

Furthermore, in some embodiments, the at least two heterogeneous formats include a first data format and a second data format. Accordingly, for operation S402, the operation that the metadata decoding is performed on the spliced atlas information to obtain the auxiliary information of each of at least two heterogeneous formats may include following operations.

When auxiliary information being decoded currently is information corresponding to the first data format in the spliced atlas information, the decoding is performed, by invoking a metadata decoder corresponding to the first data format, to obtain auxiliary information corresponding to the first data format.

When auxiliary information being decoded currently is information corresponding to the second data format in the spliced atlas information, the decoding is performed, by invoking a metadata decoder corresponding to the second data format, to obtain auxiliary information corresponding to the second data format.

It is to be noted that the patch corresponding to the first data format and the patch corresponding to the second data format coexisting in one spliced picture may be obtained through performing the decoding by one video decoder. However, for the virtual-reality mixing use case with the two data formats, when the corresponding information of different data formats in the spliced atlas information is decoded, if the information corresponding to the first data format is required to be decoded currently, the decoding is performed by invoking the metadata decoder corresponding to the first data format to obtain the auxiliary information corresponding to the first data format; and if the information corresponding to the second data format is required to be decoded currently, the decoding is performed by invoking the metadata decoder corresponding to the second data format to obtain the auxiliary information corresponding to the second data format.

Furthermore, in some embodiments, the at least two heterogeneous formats further comprise a third data format. Accordingly, the operation that the metadata decoding is performed on the spliced atlas information to obtain the auxiliary information of each of at least two heterogeneous formats further may further include following operation.

When the auxiliary information being decoded currently is information corresponding to the third data format in the spliced atlas information, the decoding is performed, by invoking a metadata decoder corresponding to the third data format, to obtain auxiliary information corresponding to the third data format.

That is to say, in the embodiment of the present disclosure, the at least two heterogeneous formats are not limited to the first data format and the second data format, but may even include the third data format, a fourth data format, etc. When auxiliary information of a certain data format is required to be decoded, only a corresponding metadata decoder is required to be invoked to perform the decoding. The following description is described by taking the first data format and the second data format as an example.

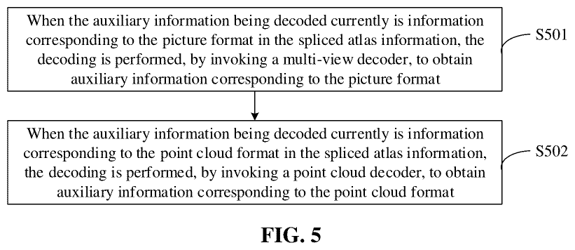

In a specific embodiment, the first data format is the picture format and the second data format is the point cloud format. Accordingly, in some embodiments, as shown in FIG. 5, operation S402 may include operations S501 to S502.

In operation S501, when the auxiliary information being decoded currently is information corresponding to the picture format in the spliced atlas information, the decoding is performed, by invoking a multi-view decoder, to obtain auxiliary information corresponding to the picture format.

In operation S502, when the auxiliary information being decoded currently is information corresponding to the point cloud format in the spliced atlas information, the decoding is performed, by invoking a point cloud decoder, to obtain auxiliary information corresponding to the point cloud format.

It is to be noted that in the embodiment of the present disclosure, the first data format is different from the second data format. The first data format may be the picture format, and the second data format may be the point cloud format. Alternatively, a projection format of the first data format is different from a projection format of the second data format, the projection format of the first data format may be a perspective projection format, and the projection format of the second data format may be an orthogonal projection format. Alternatively, the first data format may also be the mesh format, the point cloud format, or the like, and the second data format may also be the mesh format, the picture format, or the like, which is not limited herein.

It is also to be noted that, in the embodiment of the present disclosure, the point cloud format is the non-uniform sampling processing, and the picture format is the uniform sampling processing. Therefore, the point cloud format and the picture format may be used as two heterogeneous formats. In this case, a multi-view decoder may be invoked to perform the decoding for the picture format; and the point cloud decoder may be invoked to perform the decoding for the point cloud format. In this way, if the information corresponding to the picture format is required to be decoded currently, the multi-view decoder is required to be invoked to perform the decoding to obtain the auxiliary information corresponding to the picture format; and if the information corresponding to the point cloud format is required to be decoded currently, the point cloud decoder is required to be invoked to perform the decoding to obtain the auxiliary information corresponding to the point cloud format. Therefore, both the rendering characteristics from the picture format and the rendering characteristics from the point cloud format can be retained.

Furthermore, in some embodiments, for operation S403, the operation that the video decoding is performed on the video data to be decoded to obtain the spliced picture may include following operation.

The video decoding is performed, by invoking a video decoder, on the video data to be decoded to obtain the spliced picture, where a number of the video decoders is one.

That is to say, the patches corresponding to at least two heterogeneous formats coexisting in one spliced picture may be obtained through performing the decoding by one video decoder. In this way, compared with the related technology in which the encoding is performed separately and then the decoding is performed independently on each of the multiple signals by invoking a respective decoder, the number of video decoders required to be invoked is less in the embodiment of the present disclosure, and the processing pixel rate of the video decoder can be fully utilized, so that the requirement for the hardware is reduced.

Specifically, the patches corresponding to a plurality of heterogeneous formats in the spliced picture may be obtained through performing the decoding by one video decoder. However, for the auxiliary information of each of the plurality of heterogeneous formats in the spliced atlas information, a respective metadata decoder may be invoked to perform the decoding, so as to obtain the auxiliary information corresponding to different heterogeneous formats. Exemplarily, if the information corresponding to the point cloud format in the spliced atlas information is required to be decoded, the point cloud decoder may be invoked to perform the decoding to obtain the auxiliary information corresponding to the point cloud format. If the information corresponding to the picture format in the spliced atlas information is required to be decoded, the multi-view decoder may be invoked to perform the decoding to obtain the auxiliary information corresponding to the picture format, which is not limited in the embodiment of the present disclosure.

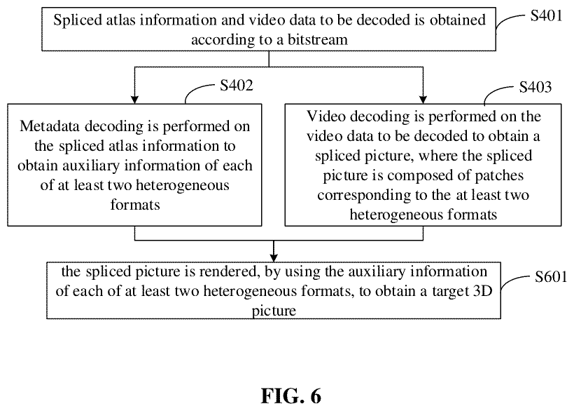

Furthermore, after the auxiliary information of each of the at least two heterogeneous formats and the spliced picture are obtained, in some embodiments, as shown in FIG. 6, the method may further includes operation S601.

In operation S601, the spliced picture is rendered, by using the auxiliary information of each of at least two heterogeneous formats, to obtain a target 3D picture.

In this way, in the embodiment of the present disclosure, patches corresponding to the at least two heterogeneous formats may coexist in one spliced picture, and the spliced picture is decoded by using one video decoder, thereby reducing the number of the video decoders. However, for the auxiliary information of each of the at least two heterogeneous formats, a respective metadata decoder may be invoked to perform the decoding, so that the rendering advantages from different data formats (such as the picture format, the point cloud format, etc.) can be retained, and the composition quality of the picture can be improved.

It is to be understood that in the related technology, the coexistence of different data formats, such as the point cloud format and the picture format, in one spliced picture is not supported. In the MPEG standard, common high-level syntax information has been defined for the picture format and point cloud format. In this case, the common high-level syntax information is required to be used with the picture format or point cloud format. Therefore, a flag bit of the syntax element asps_extension_present_flag is defined in the standard to indicate enabling the extension function. If the flag bit of the syntax element asps_vpcc_extension_present_flag is true (or has a value of 1), the specific decoding process in the point cloud decoding standard may be referred to. If the flag bit of the syntax element asps_miv_extension_present_flag is true (or has a value of 1), the specific decoding process in the picture decoding standard may be followed, specifically, as shown in Table 1.

TABLE 1

| | Descriptor |
|---|---|
| atlas_sequence_parameter_set_rbsp( ){ | |
| asps_atlas_sequence_parameter_set_id | ue(v) |
| asps_frame_width | ue(v) |
| asps_frame_height | ue(v) |
| .... | |
| asps_extension_present_flag | u(1) |
| if(asps_extension_present_flag){ | |
| asps_{—}vpcc_{—}extension_{—} | u(1) |
| present_{—}flag | |
| asps_{—}miv_{—}extension_{—} | u(1) |
| present_{—}flag | |
| asps_extension_6bits | u(6) |
| } | |
| if(asps_vpcc_extension_present_flag) | |
| asps_vpcc_extension( )/*SpecifiedinAnnexH*/ | |
| if(asps_miv_extension_present_flag) | |
| asps_miv_extension( )/*SpecifiedinISO/IEC23090-12*/ | |
| if(asps_extension_6bits) | |
| while(more_rbsp_data( )) | |
| asps_extension_data_flag | u(1) |
| rbsp_trailing_bits( ) | |
| } | |

Herein, the point cloud decoding standard shown in Table 2 defines that when the flag bit of the syntax element asps_vpcc_extension_present_flag is true (or has a value of 1), the flag bits of the relevant syntax elements (sections of the syntax elements with ‘italic expression’) involved in the picture decoding standard extension are all false (or have a value of 0). The details are shown below. Therefore, each of the point cloud decoding standard (such as the V-PCC standard) and the picture decoding standard (such as the MIV standard) may not support that both the flag bit of the syntax element asps_vpcc_extension_present_flag and the flag bit of the syntax element asps_miv_extension_present_flag are true simultaneously.

TABLE 2

| | Profile name | | | |
|---|---|---|---|---|
| | | V-PCC | | V-PCC |
| | V-PCC | Basic | V-PCC | Extended |
| Syntax element | Basic | Still | Extended | Still |
| ptl_profile_toolset_idc | 0 | 0 | 1 | 1 |
| ptc_one_v3c_frame_only_flag | — | 1 | — | 1 |

| | | |
|---|---|---|
| asps_eom_patch_enabled_flag | 0 | — |
| asps_map_count_minus1 | Min(1, | LevelMapCount − 1 |
| | LevelMapCount − 1) | |
| vps_multiple_map_streams_present_flag | whenpresent, 1 | — |
| (whenvps_map_count_minus1>0) | | |
| vps_atlas_count_minus1 | 0 | 0 |
| asps_plr_enabled_flag | 0 | — |
| ai_attribute_dimension_minus1 | 2 | — |
| ai_attribute_dimension_partitions_minus1 | 0 | — |
| ai_attribute_partition_channels_minus1 | — | 2 |
| asps_use_eight_orientations_flag | 0 | — |
| asps_extended_projection_enabled_flag | 0 | — |
| vps_auxiliary_video_present_flag | — | — |
| vps_occupancy_video_present_flag | 1 | 1 |
| vps_geometry_video_present_flag | 1 | 1 |
| vps_attribute_video_present_flag | — | — |
| vps_extension_present_flag | 0 | 0 |
| vps_packing_information_present_flag | 0 | 0 |
| vps_{—}miv_{—}extension_{—}present_{—}flag | 0 | 0 |
| asps_{—}miv_{—}extension_{—}present_{—}flag | 0 | 0 |
| casps_{—}extension_{—}present_{—}flag | 0 | 0 |
| casps_{—}miv_{—}extension_{—}present_{—}flag | 0 | 0 |
| caf_{—}extension_{—}present_{—}flag | 0 | 0 |
| caf_{—}miv_{—}extension_{—}present_{—}flag | 0 | 0 |
| vuh_unit_type | V3C_VPS, | V3C_VPS, |
| | V3C_AD, V3C_OVD, | V3C_AD, V3C_OVD, |
| | V3C_GVD, or | V3C_GVD, or |
| | V3C_AVD | V3C_AVD |

That is to say, when the V-PCC standard or the MIV standard is used, only one of the flag bit of the syntax element asps_vpcc_extension_present_flag and the flag bit of the syntax element asps_miv_extension_present_flag may be true, and it is unable to deal with the case where both of the two are true. Based on this, the embodiment of the present disclosure provides a decoding method, which may implement that the patches of different data formats, such as the point cloud format and the picture format, coexist in one spliced picture, so as to implement the aforementioned advantage of saving the number of video decoders, and also retain the rendering characteristics from different data formats, such as the point cloud format and the picture format, and improve the composition quality of the picture.

That is to say, the embodiment of the present disclosure is provided with a target syntax element profile, and the target syntax element profile indicates that the coexistence of the patches corresponding to the at least two heterogeneous formats in one spliced picture may be supported. In this way, when the patches corresponding to different data formats, such as the point cloud format and the picture format, coexist in one spliced picture, the decoding processing by one video decoder may be implemented in the embodiment of the present disclosure.

Herein, the target syntax element profile may be obtained by extending on the basis of an initial syntax element profile. That is to say, the target syntax element profile may consist of an initial profile part and a mixed profile part. In a specific embodiment, the initial profile part indicates that the coexistence of the patch corresponding to the picture format and the patch corresponding to the point cloud format in one spliced picture is not supported. The mixed profile part indicates that the coexistence of the patch corresponding to the picture format and the patch corresponding to the point cloud format in one spliced picture may be supported.

Exemplarily, taking the MIV decoding standard and the V-PCC decoding standard as an example, herein, the initial syntax element profile or, in other words, the initial profile part only supports the patch corresponding to the picture format; and it is explicitly pointed out that the patch corresponding to the picture format and the patch corresponding to the point cloud format cannot coexist in one spliced picture. Due to the addition of the mixed profile part, the target syntax element profile may support the coexistence of the patch corresponding to picture format and the patch corresponding to point cloud format in one spliced picture, as shown in Table 3 for details. Table 3 is obtained by expanding on the basis of the MIV syntax element profile existed in the standard, and the part with ‘italic expression’ is the content of the newly added mixed profile part in the embodiment of the present disclosure.

TABLE 3

| | Profile name | | | | | | | |
|---|---|---|---|---|---|---|---|---|
| | | | | | | | MIV | |
| | | | | | | | Extended | MIV |
| | | | MIV | | MIV | MIV | Restricted | Geometry |
| | | | Extended | MIV | Main | Extended | Geometry | Absent |
| | MIV | MIV | Restricted | Geometry | Mixed | Mixed | Mixed | Mixed |
| Syntax element | Main | Extended | Geometry | Absent | V-PCC | V-PCC | V-PCC | V-PCC |
| . . . | | | | | | | | |
| asps_vpcc_extension_present_flag | 0 | 0 | 0 | 0 | 1 | 1 | 1 | 1 |
| aaps_vpcc_extension_present_flag | 0 | 0 | 0 | 0 | 1 | 1 | 1 | 1 |
| . . . | | | | | | | | |
| vps_occupancy_video_present_flag[atlasID] | 0 | 0, 1 | 0 | 0 | 1 | 1 | 1 | 1 |
| ai_attribute_count[atlasID] | 0, 1 | 0, 1, 2 | 2 | 0, 1 | — | — | — | — |
| . . . | | | | | | | | |

It is to be noted that, Table 3 provides an example of a target syntax element profile. The target syntax element profile is only a specific example, except that the flag bit of the syntax element vps_occupancy_video_present_flag [atlasID] is determined to be 1 (due to the reason for the point cloud projection method, occupancy information must be presented), the flag bits of remaining syntax elements may not be limited. For example, the syntax element ai_attribute_count [atlasID] may not be limited (other than texture and transparency, the point cloud also support reflection, material and other attributes). In short, Table 3 is only an example, and it is not specifically limited in the embodiment of the present disclosure.

It is also to be noted that, in Table 3, some syntax elements related to the mixture of the picture format and the point cloud format are newly added. That is to say, the target syntax element profile may be consisted of the initial profile part and a mixed profile part. Thus, in some embodiments, the method may also include following operations.

A value of flag information of a syntax element is acquired according to the bitstream.

When the flag information of the syntax element indicates that a coexistence of the patches corresponding to the at least two heterogeneous formats in the spliced picture is not supported in an initial profile part, and the coexistence of the patches corresponding to the at least two heterogeneous formats in the spliced picture is supported in a mixed profile part, obtaining, according to the bitstream, the spliced atlas information and the data to be decoded.

In a specific embodiment, the operation that the value of the flag information of the syntax element is obtained according to the bitstream may include following operations.

When the value of the flag information of the syntax element is a first value in the initial profile part, it is determined that the flag information of the syntax element indicates that the coexistence of the patches corresponding to the at least two heterogeneous formats in the spliced picture is not supported in the initial profile part.

When the value of the flag information of the syntax element is a second value in the mixed profile part, it is determined that the flag information of the syntax element indicates that the coexistence of the patches corresponding to the at least two heterogeneous formats in the spliced picture is supported in the mixed profile part.

It is to be noted that the method may further include following operations: when the value of the flag information of the syntax element is a second value in the initial profile part, it is determined that the flag information of the syntax element indicates that the coexistence of the patches corresponding to the at least two heterogeneous formats in the spliced picture is supported in the initial profile part; or, when the value of the flag information of the syntax element is a first value in the mixed profile part, it is determined that the flag information of the syntax element indicates that the coexistence of the patches corresponding to the at least two heterogeneous formats in the spliced picture is not supported in the mixed profile part.

In the embodiment of the present disclosure, the first value is different from the second value. The first value is equal to 0 and the second value is equal to 1. Alternatively, the first value is equal to 1 and the second value is equal to 0. Alternatively, the first value is false, the second value is true, and so on. In a specific embodiment, the first value is equal to 0 and the second value is equal to 1, which is not limited herein.

That is to say, a limitation of a flag bit related to V-PCC extension is added into the initial syntax element profile of the standard. Herein, two syntax elements, asps_vpcc_extension_present_flag and aaps_vpcc_extension_present_flag, are added, and the value of the flag information of the syntax element in the initial profile part is explicitly 0, that is, it is clear that the picture format cannot coexist with the point cloud format. Therefore, a new profile defined herein (i.e., the target syntax element profile shown in Table 3) may support this case. If in the a virtual-reality mixing use case, when the auxiliary information is decoded, if the picture format is presented, the corresponding picture decoding standard (i.e., the picture decoder) is invoked, and if the point cloud format is presented, the point cloud decoding standard (i.e., the point cloud decoder) is invoked. Then all pixels are recovered in the 3D space, and then projected to the target viewpoint.

It is also to be noted that the parsing of syntax elements, the decoding process of the point cloud format and the decoding process of the picture format recorded in the relevant standards are introduced into the decoding process of the new profile (i.e., the target syntax element profile described in the embodiment of the present disclosure). Exemplarily, the decoding process of the MIV Main Mixed V-PCC Profile is from the related decoding processes of the MIV Main and V-PCC, and so on. In addition, there are four types of V-PCC profiles in the standard, as shown in Table 4.

TABLE 4

Profile Name

| | | | | |
|---|---|---|---|---|
| Syntax element | V-PCC | V-PCC | V-PCC | V-PCC |
| | Basic | Basic | Extended | Extended |
| | | Still | | Still |

Therefore, since there are four types of MIV profiles and four types of V-PCC profiles as follows, there are a total of 16 combinations of MIV Mixed V-PCC, as shown below.

TABLE 5

| | V-PCC Profile Name | | | |
|---|---|---|---|---|
| | | V-PCC | | V-PCC |
| | V-PCC | Basic | V-PCC | Extended |
| MIV Profile Name | Basic | Still | Extended | Still |

MIV Main
MIV Extended
MIV Extended
Restricted Geometry
MIV Geometry Absent

Furthermore, in some embodiments, after the bitstream conforming to the mixed V-PCC Profile is decoded, rendering processing is also required, which may include the following operations: scaling geometry, applying patch attribute offset process, filtering inpaint patches, reconstructing pruned views, determining view blending weights based on a viewport pose, recovering sample weights, reconstructing 3D points, reconstructing 3D point cloud specified in the standard, projecting to a viewport, fetching texture from multiple views, blending texture contributions, and the like. The operation of “reconstructing 3D point cloud specified in the standard” is a newly added operation in the embodiment of the present disclosure, so as to implement the virtual-reality mixing.

In short, according to the decoding method for virtual-reality mixing provided in the embodiment of the present disclosure, if the patch of the picture format and the point cloud format or the patches of different projection formats coexist in one spliced picture, for the decoding of the auxiliary information, the metadata decoder needs to distinguish whether the metadata decoding is performed on the picture part or on the point cloud part. However, only one video decoder is required for the spliced picture, that is, the number of the video decoders required is small. Specifically, not only the expansion of the standard can be implemented, but also for the use case composed of different (or heterogeneous) data formats and homogeneous data format in the scene, a real-time immersive video interaction service can be provided for multiple data formats (such as the picture format, the point cloud format, the mesh format, etc.) with different origins in this manner, which may promote the development of the VR/AR/MR industry.

In addition, in the embodiment of the present disclosure, the mixed encoding is [00103] performed on the picture format and the point cloud format, compared with the method that encoding is performed separately and then the decoding is performed independently on each of the multiple signals by invoking a respective decoder, the number of the video decoders required to be invoked herein is less, the processing pixel rate of the video decoder is fully utilized, and the requirement for the hardware is reduced. In addition, according to the embodiment of the present disclosure, the rendering advantages from data formats (i.e., the mesh format, the point cloud format, etc.) with different origins can be retained, and the composition quality of the picture can also be improved.

The embodiment of the present disclosure provides a decoding method. According to the decoding method, the spliced atlas information and video data to be decoded are obtained according to a bitstream. The metadata decoding is performed on the spliced atlas information to obtain auxiliary information of each of at least two heterogeneous formats. The video decoding is performed on the video data to be decoded to obtain a spliced picture, where the spliced picture is composed of patches corresponding to the at least two heterogeneous formats. In this way, the visual data corresponding to the at least two heterogeneous formats are supported in the same atlas, and then the respective auxiliary information of the at least two heterogeneous formats may be decoded by using different metadata decoders, and the spliced picture composed of the at least two heterogeneous formats may be decoded by using one video decoder, thereby not only implementing the expansion of the codec standards, but also reducing the demand for the number of the video decoders, making full use of the processing pixel rate of the video decoder, and reducing the requirement for the hardware. In addition, since rendering characteristics from different heterogeneous formats can be retained, the composition quality of the picture is also improved.

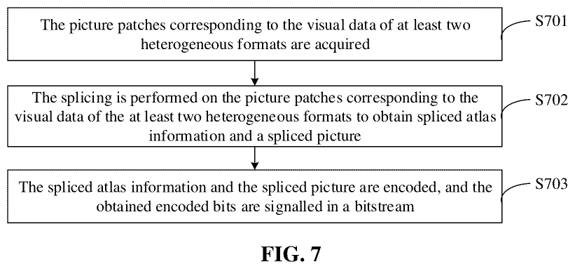

In another embodiment of the present disclosure, with reference to FIG. 7 showing a flowchart of an encoding method according to an embodiment of the present disclosure. As shown in FIG. 7, the method may include operations S701 to S703.

In operation S701, the patches corresponding to the visual data of at least two heterogeneous formats are acquired.

In operation S702, the splicing is performed on the patches corresponding to the visual data of the at least two heterogeneous formats, to obtain spliced atlas information and a spliced picture.

In operation S703, the spliced atlas information and the spliced picture are encoded, and the obtained encoded bits are signalled in a bitstream.

It is to be noted that the encoding method described in the embodiment of the present disclosure may specifically refer to an encoding method for 3D heterogeneous visual data. In the embodiment of the present disclosure, the patches corresponding to different heterogeneous formats, such as the point cloud and the picture, may coexist in one spliced picture. In this way, after the spliced picture composed of the patches corresponding to the visual data of the at least two heterogeneous formats is encoded, the spliced picture may be decoded by only one video decoder, so that the demand for the number of the video decoders can be reduced.

It is also to be noted that, in the embodiment of the present disclosure, one video decoder is used for the sequences belonging to the same spliced picture, while different spliced pictures at the same moment belong to different sequences. In addition, the heterogeneous format described in the embodiment of the present disclosure may indicate that the origins of the data are different, or that the same origin is processed into different data formats, which is not limited herein.

It is also to be noted that, in the embodiment of the present disclosure, the spliced atlas information may be formed by splicing the respective pieces of auxiliary information of the visual data of at least two heterogeneous formats. The spliced picture is formed by splicing the patches corresponding to the visual data of the at least two heterogeneous formats.

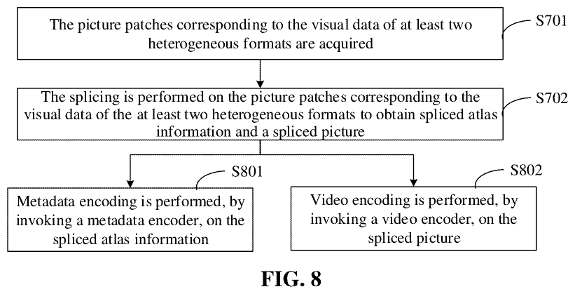

Furthermore, in some embodiments, as shown in FIG. 8, operation S703 may include operations S801 to S802.

In operation S801, metadata encoding is performed, by invoking a metadata encoder, on the spliced atlas information.

In operation S802, video encoding is performed, by invoking a video encoder, on the spliced picture.

That is to say, the auxiliary information of different data formats, such as the point cloud and the picture, may coexist in the same atlas. However, in the spliced atlas information, the auxiliary information of each heterogeneous format may be encoded by invoking a respective metadata encoder.

For the spliced picture, the patches corresponding to the visual data of different data formats, such as the point cloud and the picture, may be rearranged in the same spliced picture, and then the spliced picture may be encoded by invoking a video encoder.

In the embodiment of the present disclosure, the number of the video encoders is one; while the number of the metadata encoders is at least two, and there is a correspondence between the number of the metadata encoders and a number of the heterogeneous formats. That is to say, the auxiliary information of each heterogeneous format may be encoded by using a respective metadata encoder. In other words, in the embodiment of the present disclosure, in case there are a number of types of heterogeneous formats of which the auxiliary information is included in the spliced atlas information, a same number of kinds of metadata encoders are required.

Furthermore, in some embodiments, the at least two heterogeneous formats include a first data format and a second data format. Accordingly, the operation that the metadata encoding is performed, by invoking the metadata encoder, on the spliced atlas information may include following operations.

When the auxiliary information being encoded currently is information corresponding to the first data format in the spliced atlas information, the encoding is performed by invoking a metadata encoder corresponding to the first data format.

When the auxiliary information being encoded currently is information corresponding to the second data format in the spliced atlas information, the encoding is performed by invoking a metadata encoder corresponding to the second data format.

It is to be noted that the patch corresponding to the first data format and the patch corresponding to the second data format coexisting in one spliced picture may be encoded by one video encoder. However, for the virtual-reality mixing use case with the two data formats, when the auxiliary information of different data formats in the spliced atlas information is encoded, if the auxiliary information currently to be encoded is the information corresponding to the first data format, the encoding is performed by invoking the metadata encoder corresponding to the first data format; and if the auxiliary information to be encoded currently is the information corresponding to the second data format, the encoding is performed by invoking the metadata encoder corresponding to the second data format.

Furthermore, in some embodiments, the at least two heterogeneous formats further comprise a third data format. Accordingly, the operation that the metadata encoding is performed, by invoking the metadata encoder, on the spliced atlas information further includes following operation.

When the auxiliary information being encoded currently is information corresponding to the third data format in the spliced atlas information, the encoding is performed by invoking a metadata encoder corresponding to the third data format.

That is to say, in the embodiment of the present disclosure, the at least two heterogeneous formats are not limited to the first data format and the second data format, but may even include the third data format, a fourth data format, etc. When auxiliary information of a certain data format is required to be encoded, only a corresponding metadata encoder is required to be invoked to perform the decoding. The following description is described by taking the first data format and the second data format as an example.

In a specific embodiment, the first data format is the picture format and the second data format is the point cloud format. Accordingly, the operation that the metadata encoding is performed, by invoking the metadata encoder, on the spliced atlas information may include following operations.

When the auxiliary information being encoded currently is information corresponding to the picture format in the spliced atlas information, the encoding is performed by invoking a multi-view encoder.

When the auxiliary information being encoded currently is information corresponding to the point cloud format in the spliced atlas information, the encoding is performed by invoking a point cloud encoder.

It is to be noted that in the embodiment of the present disclosure, the first data format is different from the second data format. The first data format may be the picture format, and the second data format may be the point cloud format. Alternatively, a projection format of the first data format is different from a projection format of the second data format, the projection format of the first data format may be a perspective projection format, and the projection format of the second data format may be an orthogonal projection format. Alternatively, the first data format may also be the mesh format, the point cloud format, or the like, and the second data format may also be the mesh format, the picture format, or the like, which is not limited herein.

It is also to be noted that, in the embodiment of the present disclosure, the point cloud format is the non-uniform sampling processing, and the picture format is the uniform sampling processing. Therefore, the point cloud format and the picture format may be used as two heterogeneous formats. In this case, a multi-view encoder may be invoked to perform the decoding for the auxiliary information of the picture format; and a point cloud encoder may be invoked to perform the decoding for the auxiliary information of the point cloud format. In this way, if the auxiliary information required to be encoded currently is the information corresponding to the picture format, the multi-view encoder is required to be invoked to perform the decoding; and if the auxiliary information required to be encoded currently is the information corresponding to the point cloud format, the point cloud encoder is required to be invoked to perform the decoding, such that when the decoding process is performed on the decoding side, both the rendering characteristics from the picture format and the rendering characteristics from the point cloud format can be retained.

In this way, in the embodiment of the present disclosure, patches corresponding to the visual data of at least two heterogeneous formats may coexist in one spliced picture, and the spliced picture may be encoded by using one video encoder, thereby reducing the number of the video encoders. Since one video decoder is used for decoding in the future, the number of the video decoders is also reduced. However, for the auxiliary information of each of the at least two heterogeneous formats, a respective metadata encoder may be invoked to perform the encoding, and then the respective metadata decoder may be invoked to perform decoding during the decoding process. Therefore, the rendering advantages from different data formats (such as the picture format, the point cloud format, etc.) can be retained, so as to improve the composition quality of the picture.

It is to be understood that, in the embodiment of the present disclosure, the target syntax element profile may be obtained by extending on the basis of the initial syntax element profile already existed in the standard. That is to say, the target syntax element profile may consist of an initial profile part and a mixed profile part. In a specific embodiment, the initial profile part indicates that the coexistence of the patch corresponding to the picture format and the patch corresponding to the point cloud format in one spliced picture is not supported. The mixed profile part indicates that the coexistence of the patch corresponding to the picture format and the patch corresponding to the point cloud format in one spliced picture may be supported.

Herein, exemplarily, the initial syntax element profile or, in other words, the initial profile part only supports the patch corresponding to the picture format; and it is explicitly pointed out that the patch corresponding to the picture format and the patch corresponding to the point cloud format cannot coexist in one spliced picture. Due to the addition of the mixed profile part, the target syntax element profile may support the coexistence of the patch corresponding to picture formats and the patch corresponding to point cloud format in one spliced picture, as shown in Table 3 above for details.

In addition, it is to be noted that, Table 3 provides an example of a target syntax element profile. The target syntax element profile is only a specific example, except that the flag bit of the syntax element vps_occupancy_video present_flag[atlasID] is determined to be 1 (due to the reason for the point cloud projection method, occupancy information must be presented), the flag bits of remaining syntax elements may not be limited. For example, the syntax element ai_attribute_count [atlasID] may not be limited (other than texture and transparency, the point cloud also support reflection, material and other attributes). In short, Table 3 is only an example, and it is not specifically limited in the embodiment of the present disclosure.

It is also to be noted that in the Table 3 above, some syntax elements related to the mixture of the picture format and the point cloud format are newly added. That is to say, the target syntax element profile may be consisted of the initial profile part and a mixed profile part. Thus, in some embodiments, the method may also include following operations.

The value of flag information of a syntax element is determined.

The value of the flag information of the syntax element is encoded, and the obtained encoded bits are signalled in a bitstream.

In a specific embodiment, the operation that the value of the flag information of the syntax element is determined may include following operations.

When the flag information of the syntax element indicates that a coexistence of the patches corresponding to the at least two heterogeneous formats in the spliced picture is not supported in an initial profile part, it is determined that the value of the flag information of the syntax element is a first value in the initial profile part.

When the flag information of the syntax element indicates that the coexistence of the patches corresponding to the at least two heterogeneous formats in the spliced picture is supported in a mixed profile part, it is determined that the value of the flag information of the syntax element is a second value in the mixed profile part.

It is to be noted that the method may further include following operations: when the flag information of the syntax element indicates that a coexistence of the patches corresponding to the at least two heterogeneous formats in the spliced picture is supported in an initial profile part, it is determined that the value of the flag information of the syntax element is a second value in the initial profile part; or, when the flag information of the syntax element indicates that the coexistence of the patches corresponding to the at least two heterogeneous formats in the spliced picture is not supported in a mixed profile part, it is determined that the value of the flag information of the syntax element is a first value in the mixed profile part.

In the embodiment of the present disclosure, the first value is different from the second value. The first value is equal to 0 and the second value is equal to 1. Alternatively, the first value is equal to 1 and the second value is equal to 0. Alternatively, the first value is false, the second value is true, and so on. In a specific embodiment, the first value is equal to 0 and the second value is equal to 1, which is not limited herein.

That is to say, a limitation of a flag bit related to V-PCC extension is added into the initial syntax element profile of the standard. Herein, two syntax elements, asps_vpcc_extension_present_flag and aaps_vpcc_extension_present_flag, are added, and the value of the flag information of the syntax element in the initial profile part is explicitly 0, that is, it is clear that the picture format cannot coexist with the point cloud format. Therefore, a new profile defined herein (i.e., the target syntax element profile shown in Table 3) may support this case. If in the a virtual-reality mixing use case, when the auxiliary information is encoded, if the picture format is presented, the corresponding picture encoding standard (i.e., the picture encoder) is invoked, and if the point cloud format is presented, the point cloud encoding standard (i.e., the point cloud encoder) is invoked, so that the corresponding metadata decoders are invoked for decoding during subsequent decoding process. In this way, when all pixels are recovered in a 3D space and then projected to the target viewpoint, the rendering advantages from different data formats (such as the picture format, the point cloud format, etc.) can be retained, so as to improve the composition quality of the picture.

In short, the encoding method for virtual-reality mixing provided by the embodiment of the present disclosure may specifically refer to the encoding method for 3D heterogeneous visual data. In this case, if the patch of the picture format and the patch of the point cloud format coexist in one spliced picture or the patches with different projection formats coexist in one spliced picture, for the encoding of the auxiliary information, the metadata encoder needs to distinguish whether the metadata encoding is performed on the picture part or on the point cloud part. However, only one video encoder is required for the spliced picture, that is, the number of video encoders required is small. Specifically, not only the expansion of the standard can be implemented, but also for the use case composed of different (or heterogeneous) data formats and homogeneous data format in the case, a real-time immersive video interaction service can be provided for multiple data formats (such as the picture format, the point cloud format, the mesh format, etc.) with different origins in this manner, which may promote the development of the VR/AR/MR industry.

In addition, in the embodiment of the present disclosure, the mixed encoding is performed on the picture format and the point cloud format, compared with the method that encoding is performed separately and then the decoding is performed independently on each of the multiple signals by invoking a respective decoder, the number of the video codecs required to be invoked herein is less, and the requirement for the hardware is reduced. In addition, according to the embodiment of the present disclosure, the rendering advantages from data formats (i.e., the mesh format, the point cloud format, etc.) with different origins can be retained, and the composition quality of the picture can also be improved.

The embodiment of the present disclosure also provides an encoding method. According to the encoding method, patches corresponding to visual data of at least two heterogeneous formats are acquired; splicing is performed on the patches corresponding to the visual data of the at least two heterogeneous formats to obtain spliced atlas information and a spliced picture; and the spliced atlas information and the spliced picture are encoded, and the obtained encoded bits are signalled in the bitstream. In this way, the visual data corresponding to the at least two heterogeneous formats are supported in the same atlas, which not only the expansion of the codec standards is implemented, but also the demand for the number of the video decoders is reduced, it may make full use of the processing pixel rate of the video decoder, and the requirement for the hardware is reduced. In addition, since rendering characteristics from different heterogeneous formats can be retained, the composition quality of the picture is also improved.

In another embodiment of the present disclosure, the embodiment of the present disclosure provides a bitstream generated by performing bit encoding based on information to be encoded.

In the embodiment of the present disclosure, the information to be encoded includes at least one of: spliced atlas information, a spliced picture or a value of flag information of a syntax element. The value of the flag information of the syntax element is used for clarifying that different formats, such as the picture and the point cloud, cannot coexist in the same spliced picture in related technology. However, the embodiment of the present disclosure may support the coexistence of different formats, such as the picture and the point cloud, on the same spliced picture. In this way, the visual data corresponding to the at least two heterogeneous formats are supported in the same atlas, and then the auxiliary information of the at least two heterogeneous formats may be decoded by using different metadata decoders, and the spliced picture composed of the at least two heterogeneous formats may be decoded by using one video decoder, thereby not only implementing the expansion of the codec standards, but also reducing the demand for the number of the video decoders, making full use of the processing pixel rate of the video decoder, and reducing the requirement for the hardware. In addition, since rendering characteristics from different heterogeneous formats can be retained, the composition quality of the picture is also improved.

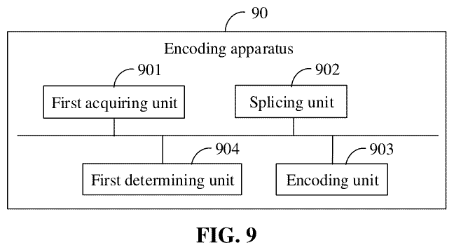

In another embodiment of the present disclosure, based on the same invention concept as the preceding embodiments, with reference to FIG. 9, FIG. 9 shows a schematic diagram of a composition structure of an encoding apparatus 90 according to an embodiment of the present disclosure. As shown in FIG. 9, the encoding apparatus 90 may include: a first acquiring unit 901, a splicing unit 902, and an encoding unit 903.

The first acquiring unit 901 is configured to acquire patches corresponding to visual data of at least two heterogeneous formats;

The splicing unit 902 is configured to perform splicing on the patches corresponding to the visual data of the at least two heterogeneous formats to obtain spliced atlas information and a spliced picture.

The encoding unit 903 is configured to encode the spliced atlas information and the spliced picture, and signal the obtained encoded bits in the bitstream.

In some embodiments, the spliced atlas information is formed by splicing respective pieces of auxiliary information of the visual data of at least two heterogeneous formats. The spliced picture is formed by splicing patches corresponding to the visual data of the at least two heterogeneous formats.

In some embodiments, the encoding unit 903 is specifically configured to perform, by invoking a metadata encoder, metadata encoding on the spliced atlas information; and perform, by invoking a video encoder, video encoding on the spliced picture.

In some embodiments, the number of the video encoders is one; and the number of the metadata encoders is at least two, and there is a correspondence between the number of the metadata encoders and a number of the heterogeneous formats.

In some embodiments, the at least two heterogeneous formats comprise a first data format and a second data format. Accordingly, the encoding unit 903 is further configured to: perform, by invoking a metadata encoder corresponding to the first data format, the encoding when the auxiliary information being encoded currently is information corresponding to the first data format in the spliced atlas information; and perform, by invoking a metadata encoder corresponding to the second data format, the encoding when the auxiliary information being encoded currently is information corresponding to the second data format in the spliced atlas information.

In some embodiments, the first data format is the picture format and the second data format is the point cloud format. Accordingly, the encoding unit 903 is further configured to: perform, by invoking a multi-view encoder, the encoding when the auxiliary information being encoded currently is information corresponding to the picture format in the spliced atlas information; and perform, by invoking a point cloud encoder, the encoding when the auxiliary information being encoded currently is information corresponding to the point cloud format in the spliced atlas information.

In some embodiments, the at least two heterogeneous formats further comprise a third data format. Accordingly, the encoding unit 903 is further configured to: perform, by invoking a metadata decoder corresponding to the third data format, the decoding when the auxiliary information being encoded currently is information corresponding to the third data format in the spliced atlas information.

In some embodiments, with reference to FIG. 9, the encoding apparatus 90 may further include a first determining unit 904 configured to determine a value of flag information of the syntax element.

The encoding unit 903 is further configured to: encode the value of the flag information of the syntax element and signal the obtained encoded bits in the bitstream.

In some embodiments, the first determining unit 904 is specifically configured to: determine that the value of the flag information of the syntax element is a first value in the initial profile part when the flag information of the syntax element indicates that a coexistence of the patches corresponding to the at least two heterogeneous formats in the spliced picture is not supported in an initial profile part; and determine that the value of the flag information of the syntax element is a second value in the mixed profile part when the flag information of the syntax element indicates that the coexistence of the patches corresponding to the at least two heterogeneous formats in the spliced picture is supported in a mixed profile part.

In some embodiments, the first value is equal to 0 and the second value is equal to 1.

It is to be understood that in the embodiments of the present disclosure, a “unit” may be a part of a circuit, a part of a processor, a part of programs or software, etc., of course it may also be a module, or it may be non-modular. Moreover, the various components in the embodiments of the present disclosure may be integrated in one processing unit, or each unit may exist physically alone, or two or more units may be integrated in one unit. The integrated unit can be implemented either in the form of hardware or in the form of software function module.

If the integrated unit is implemented in the form of software functional modules and sold or used as an independent product, it can be stored in a computer readable storage medium. Based on such understanding, the technical solution of the present disclosure, the technical scheme of the embodiment of the present application can be embodied in the form of software products in essence or the part that contributes to the prior art. The computer software product is stored in a storage medium, includes several instructions for making a computer device (which can be a personal computer, a server, a network device, etc.) or a processor to perform all or part of the steps of the method according to each embodiment of the present disclosure. The aforementioned storage media include: a U disk, a removable hard disk, a Read Only Memory (ROM), a Random Access Memory (RAM), a disk or an optical disk and other media that can store program codes.

Thus, embodiments of the present disclosure provide a computer storage medium having stored therein a computer program that, when executed by a first processor, cause the first processor to implement the method of any of the preceding embodiments.

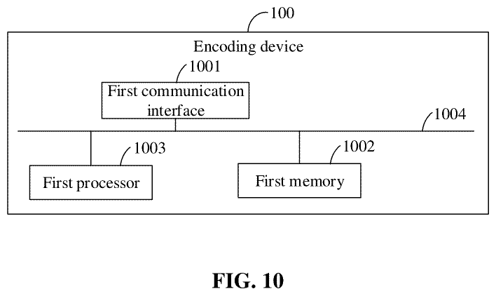

Based on the composition of the encoding apparatus 90 and the computer storage medium described above, with reference to FIG. 10, FIG. 10 shows a schematic diagram of a specific hardware structure of an encoding apparatus 90 according to an embodiment of the disclosure. As shown in FIG. 10, the encoding device 100 may include a first communication interface 1001, a first memory 1002 and a first processor 1003. The components are coupled together via a first bus system 1004. It is to be understood that the first bus system 1004 is configured to implement connection communication between these components. The first bus system 1004 includes a power bus, a control bus and a status signal bus in addition to a data bus. However, for the sake of clarity, the various buses are designated in FIG. 10 as the first bus system 1004.

The first communication interface 1001 is configured to receive and send signal in the process of sending and receiving information with other external network elements.

The first memory 1002 is configured to store computer programs capable of running on the first processor 1003.

The first processor 2003 is configured to run the computer programs to perform the following three operations.

The patches corresponding to the visual data of at least two heterogeneous formats are acquired.

The splicing is performed on the patches corresponding to the visual data of the at least two heterogeneous formats to obtain spliced atlas information and a spliced picture.

The spliced atlas information and the spliced picture are encoded, and the obtained encoded bits are signalled in the bitstream.

It will be appreciated that the first memory 1002 in the embodiments of the present disclosure may be volatile memory or non-volatile memory and may also include both volatile and non-volatile memory. The non-volatile memory can be Read Only Memory (ROM), Programmable Read-Only Memory (PROM), Erasable Programmable Read-Only Memory (EPROM), Electrically Erasable Programmable Read-Only Memory (EEPROM), or flash memory. The volatile memory may be a Random Access Memory (RAM) which serves as an external cache. By way of illustration but not limitation, many forms of the RAM are available, for example, Static Random Access Memory (RAM), Dynamic Random Access Memory (DRAM), Synchronous Dynamic Random Access Memory (SDRAM), Double Data Rate Synchronous Dynamic Random Access Memory (DDRSDRAM), Enhanced Synchronous Dynamic Random Access Memory (ESDRAM), SyncLink Dynamic Random Access Memory (SLDRAM), and Direct Rambus Random Access Memory (DRRAM). The first memory 1002 of the systems and methods described in the embodiments of the present disclosure is intended to include but not limited to these and any other suitable types of memory.

The first processor 1003 may be an integrated circuit chip having signal processing capability. In the implementation, the operations of the above method may be accomplished by integrated logic circuitry of hardware in processor 1003 or by instructions in the form of software. The first processor 1003 described above may be a general purpose processor, a Digital Signal Processor (DSP), Application Specific Integrated Circuit (ASIC), Field Programmable Gate Array (FPGA), or other programmable logic device, a discrete gate, transistor logic device, or a discrete hardware component or the like. Each method, step and logical block diagram disclosed in the embodiments of the disclosure may be implemented or executed. The universal processor may be a microprocessor or the processor may also be any conventional processor and the like. The operations of the method disclosed in combination with the embodiments of the disclosure may be directly embodied to be executed and completed by a hardware decoding processor or executed and completed by a combination of hardware and software modules in the decoding processor. The software module may be located in a mature storage medium in this field such as a Random Access Memory (RAM), a flash memory, a Read-Only Memory (ROM), a Programmable ROM (PROM) or Electrically Erasable PROM (EEPROM) and a register. The storage medium is located in the first memory 1002, and the first processor 1003 reads information in the first memory 1002, and completes the operations of the methods in combination with hardware.

It will be appreciated that the embodiments described herein may be implemented in hardware, software, firmware, middleware, microcode or a combination thereof. For the hardware implementation, the processing unit may be implemented in one or more Application Specific Integrated Circuits (ASIC), Digital Signal Processors (DSPD), Digital Signal Processing Devices (DSPD), Programmable Logic Devices (PLD), Field-Programmable Gate Arrays (FPGA), general purpose processors, controllers, microcontrollers, microprocessors, other electronic units or combinations thereof for performing the functions described herein. For software implementations, the technology described herein may be implemented by modules (e.g. procedures, functions, etc.) that perform the functions described herein. The software codes may be stored in memory and executed by a processor. The memory can be implemented in the processor or outside the processor.

Optionally, as another embodiment, the first processor 1003 is further configured to perform the method described in any one of the preceding embodiments when the computer program is run.

The present embodiment provides an encoding device that may include the encoding apparatus 90 described in the preceding embodiments. In this way, the visual data corresponding to the at least two heterogeneous formats are supported in the same atlas, and then the auxiliary information of the at least two heterogeneous formats may be decoded by using different metadata decoders, and the spliced picture composed of the at least two heterogeneous formats may be decoded by using one video decoder, thereby not only implementing the expansion of the codec standards, but also reducing the demand for the number of the video decoders, making full use of the processing pixel rate of the video decoder, and reducing the requirement for the hardware. In addition, since rendering characteristics from different heterogeneous formats can be retained, the composition quality of the picture is also improved.

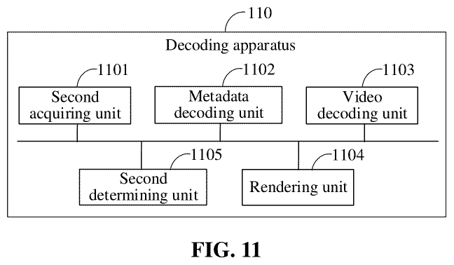

In another embodiment of the present disclosure, based on the same invention concept as the preceding embodiment, with reference to FIG. 11 showing a schematic diagram of a composition structure of a decoding apparatus 110 according to an embodiment of the present disclosure. As shown in FIG. 11, the decoding apparatus 110 may include a second acquiring unit 1101, a metadata decoding unit 1102 and a video decoding unit 1103.

The second acquiring unit 1101 is configured to obtain, according to a bitstream, spliced atlas information and video data to be decoded.

The metadata decoding unit 1102 is configured to perform metadata decoding on the spliced atlas information to obtain auxiliary information of each of at least two heterogeneous formats.

The video decoding unit 1103 is configured to perform video decoding on the video data to be decoded to obtain a spliced picture, where the spliced picture is composed of patches corresponding to the at least two heterogeneous formats.

In some embodiments, the metadata decoding unit 1102 is specifically configured to perform the metadata decoding, by invoking at least two metadata decoders, on the spliced atlas information to obtain the respective auxiliary information of at least two heterogeneous formats.

In some embodiments, the at least two heterogeneous formats comprise a first data format and a second data format. Accordingly, the metadata decoding unit 1102 is further configured to: perform, by invoking a metadata decoder corresponding to the first data format, the decoding to obtain auxiliary information corresponding to the first data format when auxiliary information being decoded currently is information corresponding to the first data format in the spliced atlas information; and perform, by invoking a metadata decoder corresponding to the second data format, the decoding to obtain auxiliary information corresponding to the second data format when auxiliary information being decoded currently is information corresponding to the second data format in the spliced atlas information.

In some embodiments, the first data format is the picture format and the second data format is the point cloud format. Accordingly, the metadata decoding unit 1102 is further configured to: perform, by invoking a multi-view decoder, the decoding to obtain auxiliary information corresponding to the picture format when the auxiliary information being decoded currently is information corresponding to the picture format in the spliced atlas information; and perform, by invoking a multi-view decoder, the decoding to obtain auxiliary information corresponding to the picture format when the auxiliary information being decoded currently is information corresponding to the picture format in the spliced atlas information.

In some embodiments, the at least two heterogeneous formats further comprise a third data format. Accordingly, the metadata decoding unit 1102 is further configured to perform, by invoking a metadata decoder corresponding to the third data format, the decoding to obtain auxiliary information corresponding to the third data format when the auxiliary information being decoded currently is information corresponding to the third data format in the spliced atlas information.

In some embodiments, the video decoding unit 1103 is specifically configured to perform the video decoding, by invoking a video decoder, on the video data to be decoded to obtain the spliced picture, where a number of the video decoders is one.

In some embodiments, with reference to FIG. 11, the decoding apparatus 110 may further include a rendering unit 1104 configured to render the spliced picture by using the auxiliary information of at least two heterogeneous formats to obtain a target 3D picture.

In some embodiments, the second acquiring unit 1101 is further configured to: acquire a value of flag information of a syntax element according to the bitstream; and obtain, according to the bitstream, the spliced atlas information and the data to be decoded when the flag information of the syntax element indicates that a coexistence of the patches corresponding to the at least two heterogeneous formats in the spliced picture is not supported in an initial profile part, and the coexistence of the patches corresponding to the at least two heterogeneous formats in the spliced picture is supported in a mixed profile part.

In some embodiments, with reference to FIG. 11, the decoding apparatus 110 may further include a second determining unit 1105 configured to: determine that the flag information of the syntax element indicates that the coexistence of the patches corresponding to the at least two heterogeneous formats in the spliced picture is not supported in the initial profile part when the value of the flag information of the syntax element is a first value in the initial profile part; and determine that the flag information of the syntax element indicates that the coexistence of the patches corresponding to the at least two heterogeneous formats in the spliced picture is supported in the mixed profile part when the value of the flag information of the syntax element is a second value in the mixed profile part.

In some embodiments, the first value is equal to 0 and the second value is equal to 1.

It is to be understood that in the embodiment, a “unit” may be part of a circuit, part of a processor, part of programs or software, etc., of course it may also be a module, or it may be non-modular. Moreover, the various components in the embodiments of the present disclosure may be integrated in one processing unit, each unit may exist physically alone, or two or more units may be integrated in one unit. The integrated unit can be implemented either in the form of hardware or in the form of software function module.

If the integrated unit is implemented in the form of software functional modules and sold or used as an independent product, it can be stored in a computer readable storage medium. Based on such understanding, the present embodiment provides a computer storage medium having stored therein a computer program that, when executed by a second processor, causes the second processor to implement the method described in any one of the preceding embodiments.

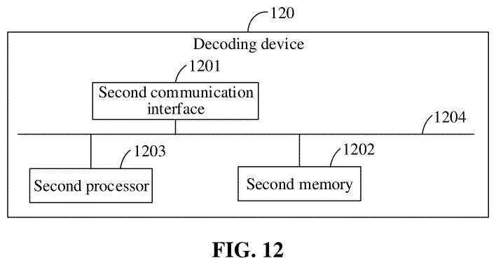

Based on the composition of the decoding apparatus 110 and the computer storage medium described above, with reference to FIG. 12 showing a schematic diagram of a specific hardware structure of a decoding device 120 according to an embodiment of the disclosure. As shown in FIG. 12, the decoding device 120 may include a second communication interface 1201, a second memory 1202 and a second processor 1203. The components are coupled together by a second bus system 1204. It is to be understood that the second bus system 1204 is configured to implement connection communication between these components. The second bus system 1204 includes a power bus, a control bus and a status signal bus in addition to a data bus. However, for the sake of clarity, the various buses are designated in FIG. 12 as the second bus system 1204.

The second communication interface 1201 is configured to receive and send signal in the process of sending and receiving information with other external network elements.

The second memory 1202 is configured to store computer programs capable of running on the first processor 1203.

The second processor 1203 is configured to run the computer programs to perform the following three operations.

Spliced atlas information and video data to be decoded are obtained according to the bitstream.

The metadata decoding is performed on the spliced atlas information to obtain the auxiliary information of each of at least two heterogeneous formats.

The video decoding is performed on the video data to be decoded to obtain a spliced picture, where the spliced picture is composed of patches corresponding to the at least two heterogeneous formats

Optionally, as another embodiment, the second processor 1203 is further configured to perform the method described in any one of the preceding embodiments when the computer program is run.

It is to be understood that the second memory 1202 has the hardware functions similar to those of the first memory 1002, and the second processor 1203 has the hardware functions similar to those of the first processor 1003, which are not described in detail.

The present embodiment provides a decoding device that may include the decoding apparatus 110 described in any of the preceding embodiments. In this way, the visual data corresponding to the at least two heterogeneous formats are supported in the same atlas, and then the auxiliary information of at least two heterogeneous formats may be decoded by using different metadata decoders, and the spliced picture composed of the at least two heterogeneous formats may be decoded by using one video decoder, thereby not only implementing the expansion of the codec standards, but also reducing the demand for the number of the video decoders, making full use of the processing pixel rate of the video decoder, and reducing the requirement for the hardware. In addition, since rendering characteristics from different heterogeneous formats can be retained, the composition quality of the picture is also improved.

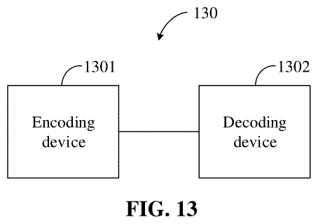

In a further embodiment of the present disclosure, with reference to FIG. 13 showing a schematic diagram of a composition structure of a codec system according to an embodiment of the present disclosure. As shown in FIG. 13, the codec system 130 may include an encoding device 1301 and a decoding device 1302. The encoding device 1301 may be the encoding device described in any one of the preceding embodiments, and the decoding device 1302 may be the decoding device described in any one of the preceding embodiments.

In the embodiment of the present disclosure, the codec system 130 may support visual data corresponding to at least two heterogeneous formats in the same atlas, thereby not only implementing the expansion of the codec standards, but also reducing the demand for the number of the video decoders, and reducing the requirement for the hardware. In addition, since rendering characteristics from different heterogeneous formats can be retained, the composition quality of the picture is also improved.

It is to be noted that, in this disclosure, the terms “include”, “contain” or any other variation thereof, are intended to cover a non-exclusive inclusion, such that a process, method, article, or device that includes a list of elements includes not only those elements but also other elements not expressly listed, or also includes elements inherent to such process, method, article, or device. Without more limitations, an element is defined by the statement “including a . . . ” that does not rule out there are additional identical elements in a process, method, article, or apparatus that includes the element.

The above-described embodiments of the present disclosure are for the purpose of description only and do not represent the advantages or disadvantages of the embodiments.

The methods disclosed in several method embodiments provided in the present disclosure can be arbitrarily combined without conflict to obtain new method embodiments.

The features disclosed in several product embodiments provided in the present disclosure can be arbitrarily combined without conflict to obtain new product embodiments.

The features disclosed in several methods or device embodiments provided in the present disclosure can be arbitrarily combined without conflict to obtain new method embodiments or device embodiments.

The above is only the specific embodiments of the disclosure, but the scope of protection of the disclosure is not limited to this. Any person skilled in the technical field who can easily think of change or replacement within the technical scope of the disclosure shall be covered in the scope of protection of the disclosure. Therefore, the protection scope of the disclosure shall be subject to the protection scope of the claims.

### Industrial Practicality

In the embodiments of the present disclosure, on the encoding side, the patches corresponding to the visual data of at least two heterogeneous formats are acquired; the splicing is performed on the patches corresponding to the visual data of the at least two heterogeneous formats to obtain spliced atlas information and a spliced picture; and the spliced atlas information and the spliced picture are encoded, and the obtained encoded bits are signalled in the bitstream. On the decoding side, spliced atlas information and video data to be decoded are obtained according to the bitstream; the metadata decoding is performed on the spliced atlas information to obtain the auxiliary information of each of at least two heterogeneous formats; and the video decoding is performed on the video data to be decoded to obtain a spliced picture, where the spliced picture is composed of patches corresponding to the at least two heterogeneous formats. In this way, the visual data corresponding to the at least two heterogeneous formats are supported in the same atlas, and then the auxiliary information of at least two heterogeneous formats may be decoded by using different metadata decoders, and the spliced picture composed of the at least two heterogeneous formats may be decoded by using one video decoder, thereby not only implementing the expansion of the codec standards, but also reducing the demand for the number of the video decoders, making full use of the processing pixel rate of the video decoder, and reducing the requirement for the hardware. In addition, since rendering characteristics from different heterogeneous formats can be retained, the composition quality of the picture is also improved.

1. A decoding method, comprising:
obtaining, according to a bitstream, spliced atlas information and video data to be decoded;
performing metadata decoding on the spliced atlas information to obtain auxiliary information of each of at least two heterogeneous formats; and
performing video decoding on the video data to be decoded to obtain a spliced picture, wherein the spliced picture is composed of patches corresponding to the at least two heterogeneous formats.

2. The method of claim 1, wherein performing the metadata decoding on the spliced atlas information to obtain the auxiliary information of each of at least two heterogeneous formats comprises:
performing, by invoking at least two metadata decoders, the metadata decoding on the spliced atlas information to obtain the auxiliary information of each of at least two heterogeneous formats.

3. The method of claim 1, wherein the at least two heterogeneous formats comprise a first data format and a second data format; and
wherein performing the metadata decoding on the spliced atlas information to obtain the auxiliary information of each of at least two heterogeneous formats comprises:
when auxiliary information being decoded currently is information corresponding to the first data format in the spliced atlas information, performing, by invoking a metadata decoder corresponding to the first data format, decoding to obtain auxiliary information corresponding to the first data format; and
when the auxiliary information being decoded currently is information corresponding to the second data format in the spliced atlas information, performing, by invoking a metadata decoder corresponding to the second data format, decoding to obtain auxiliary information corresponding to the second data format.

4. The method of claim 3, wherein the first data format is a picture format and the second data format is a point cloud format; and
wherein performing the metadata decoding on the spliced atlas information to obtain the auxiliary information of each of at least two heterogeneous formats comprises:
when the auxiliary information being decoded currently is information corresponding to the picture format in the spliced atlas information, performing, by invoking a multi-view decoder, decoding to obtain auxiliary information corresponding to the picture format; and
when the auxiliary information being decoded currently is information corresponding to the point cloud format in the spliced atlas information, performing, by invoking a point cloud decoder, decoding to obtain auxiliary information corresponding to the point cloud format.

5. The method of claim 3, wherein the at least two heterogeneous formats further comprise a third data format; and
wherein performing the metadata decoding on the spliced atlas information to obtain the auxiliary information of each of at least two heterogeneous formats further comprises:
when the auxiliary information being decoded currently is information corresponding to the third data format in the spliced atlas information, performing, by invoking a metadata decoder corresponding to the third data format, decoding to obtain auxiliary information corresponding to the third data format.

6. The method of claim 1, wherein performing the video decoding on the video data to be decoded to obtain the spliced picture comprises:
performing, by invoking a video decoder, the video decoding on the video data to be decoded to obtain the spliced picture, wherein a number of the video decoder is one.

7. The method of claim 1, further comprising:
rendering, by using the auxiliary information of each of at least two heterogeneous formats, the spliced picture to obtain a target three-dimensional (3D) picture.

8. The method of claim 1, further comprising:
obtaining a value of flag information of a syntax element according to the bitstream; and
when the flag information of the syntax element indicates that a coexistence of the patches corresponding to the at least two heterogeneous formats in the spliced picture is not supported in an initial profile part, and the coexistence of the patches corresponding to the at least two heterogeneous formats in the spliced picture is supported in a mixed profile part, obtaining, according to the bitstream, the spliced atlas information and the data to be decoded.

9. The method of claim 8, wherein obtaining the value of the flag information of the syntax element according to the bitstream comprises:
when the value of the flag information of the syntax element is a first value in the initial profile part, determining that the flag information of the syntax element indicates that the coexistence of the patches corresponding to the at least two heterogeneous formats in the spliced picture is not supported in the initial profile part; and
when the value of the flag information of the syntax element is a second value in the mixed profile part, determining that the flag information of the syntax element indicates that the coexistence of the patches corresponding to the at least two heterogeneous formats in the spliced picture is supported in the mixed profile part.

10. The method of claim 9, wherein the first value is equal to 0 and the second value is equal to 1.

11. An encoding method, comprising:
acquiring patches corresponding to visual data of at least two heterogeneous formats;
performing splicing on the patches corresponding to the visual data of the at least two heterogeneous formats to obtain spliced atlas information and a spliced picture; and
encoding the spliced atlas information and the spliced picture, and signalling obtained encoded bits in a bitstream.

12. The method of claim 11, wherein the spliced atlas information is formed by splicing respective pieces of auxiliary information of the visual data of the at least two heterogeneous formats; and
the spliced picture is formed by splicing the patches corresponding to the visual data of the at least two heterogeneous formats.

13. The method of claim 12, wherein encoding the spliced atlas information and the spliced picture comprises:
performing, by invoking a metadata encoder, metadata encoding on the spliced atlas information; and
performing, by invoking a video encoder, video encoding on the spliced picture.

14. The method of claim 13, wherein
a number of the video encoder is one; and
a number of metadata encoders is at least two, and there is a correspondence between the number of the metadata encoders and a number of the heterogeneous formats.

15. The method of claim 13, wherein the at least two heterogeneous formats comprise a first data format and a second data format, and
wherein performing, by invoking the metadata encoder, the metadata encoding on the spliced atlas information comprises:
when auxiliary information being encoded currently is information corresponding to the first data format in the spliced atlas information, performing, by invoking a metadata encoder corresponding to the first data format, encoding; and
when the auxiliary information being encoded currently is information corresponding to the second data format in the spliced atlas information, performing, by invoking a metadata encoder corresponding to the second data format, encoding.

16. The method of claim 15, wherein the first data format is a picture format and the second data format is a point cloud format; and
wherein performing, by invoking the metadata encoder, the metadata encoding on the spliced atlas information comprises:
when the auxiliary information being encoded currently is information corresponding to the picture format in the spliced atlas information, performing, by invoking a multi-view encoder, encoding; and
when the auxiliary information being encoded currently is information corresponding to the point cloud format in the spliced atlas information, performing, by invoking a point cloud encoder, encoding.

17. The method of claim 15, wherein the at least two heterogeneous formats further comprise a third data format; and
wherein performing, by invoking the metadata encoder, the metadata encoding on the spliced atlas information comprises:
when the auxiliary information being encoded currently is information corresponding to the third data format in the spliced atlas information, performing, by invoking a metadata encoder corresponding to the third data format, the encoding.

18. The method of claim 11, further comprising:
determining a value of flag information of a syntax element; and
encoding the value of the flag information of the syntax element, and signalling the obtained encoded bits in the bitstream.

19. The method of claim 18, wherein determining the value of the flag information of the syntax element comprises:
when the flag information of the syntax element indicates that a coexistence of the patches corresponding to the at least two heterogeneous formats in the spliced picture is not supported in an initial profile part, determining that the value of the flag information of the syntax element is a first value in the initial profile part; and
when the flag information of the syntax element indicates that the coexistence of the patches corresponding to the at least two heterogeneous formats in the spliced picture is supported in a mixed profile part, determining that the value of the flag information of the syntax element is a second value in the mixed profile part.

20. A decoding device, comprising a memory and a processor,
wherein the memory is configured to store computer programs executable on the processor; and
the processor is configured to, when executing the computer programs, perform following operations:
obtaining, according to a bitstream, spliced atlas information and video data to be decoded;
performing metadata decoding on the spliced atlas information to obtain auxiliary information of each of at least two heterogeneous formats; and
performing video decoding on the video data to be decoded to obtain a spliced picture, wherein the spliced picture is composed of patches corresponding to the at least two heterogeneous formats.
